(19) United States
(12) Patent Application Publication
(10) Pub. No.: US 2007/0106849 A1
(43) Pub. Date: May 10, 2007

(54) Method and system for adaptive intelligent prefetch

(75) Inventors: William H. Moore, Fremont, CA (US); Krister M. Johansen, Seattle, WA (US); Jeffrey S. Bonwick, Los Altos, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/447,536

(22) Filed: Jun. 5, 2006

Related U.S. Application Data
(60) Provisional application No. 60/733,442, filed on Nov. 4, 2005.

(51) Int. Cl. G06F 13/00

(52) U.S. Cl. 711/137

(57) ABSTRACT

A method for prefetching data in a file system includes detecting an access to a file in the file system, wherein an instance of file access information is generated upon each access to the file, placing a plurality of the instance of file access into an access history buffer, performing a collinear check between at least three of the plurality of the instance of file access information in the history buffer to determine a sequential access pattern, creating a prefetch stream based on the sequential access pattern if the collinear check succeeds, and placing the prefetch stream into the prefetch stream buffer.

### CROSS-REFERENCE TO RELATED APPLICATIONS

This application claims benefit of U.S. Provisional Application Ser. No. 60/733,442 filed on Nov. 4, 2005, entitled “METHOD AND SYSTEM FOR ADAPTIVE INTELLIGENT PREFETCH” in the names of William H. Moore, Krister M. Johansen, and Jeffrey S. Bonwick.

### BACKGROUND

File system workloads that read large quantities of data can be categorized into two general types of access patterns, namely random-access and sequential access. A random-access pattern describes a workload where the block-identifiers (“block-ids”) of all the blocks of data read from the disk do not generate a discernable pattern. Accordingly, a workload having such a random-access pattern reads blocks of data on disk in any order and may seek back and forth across offsets within a file. In contrast, a sequential access pattern describes a workload where blocks are requested from the file system in some predictable sequence. In some cases, the predictable sequence is as simple as reading every block in the file, one after the other. Other requests have more complex sequential access patterns, which may be more difficult to predict.

It is possible to observe sequential access patterns as an application makes use of the file system; it is also possible to optimize the way the file system reads blocks of data so that applications that exhibit sequential access patterns may achieve optimal performance. The process of loading blocks into memory before an application needs to use them (based on recognizing the sequential access patterns) is called prefetch, or read-ahead. If a file system is able to retrieve blocks of data that an application is going to use, before the application needs to use these blocks, the application's performance tends to improve. The improvement results from the file system performing a portion of the work for the application. Of course, application performance only improves when the file system is correctly able to predict the blocks of data that the application eventually uses. If the file system incorrectly retrieves blocks that are not used, performance suffers as the file system has performed unnecessary work.

Prefetch strategies typically handle sequential blocks, fetched in a linear fashion (i.e., one block after another). The kinds of application that benefit most from this type of prefetch are applications that copy files from one location to another, stream files sequentially, or otherwise deal with traversing a linear sequence of block-ids.

Most production file systems used by various UNIX operating systems (such as Linux, Solaris, and Berkeley Software Design (BSD), etc.) implement a simple prefetch strategy, which operates at the block-device level, and handles linear access patterns or possibly only linear access patterns in increasing block-ids. For example, prefetch strategies for Unix File System (UFS) on Solaris® (registered trademark of Sun Microsystems, Inc, Santa Clara, Calif. USA), and those employed on Linux only deal with block-ids that are increasing and which match a linear, one block after the other strategy. Today's applications frequently have multiple streams reading at different offsets within the same file. These prefetch strategies assume that only one reader is present, and that it is reading from a linearly increasing offset.

### SUMMARY

In general, in one aspect, the invention relates to a file system comprising a file accessed by the file system, wherein an instance of file access information is generated upon each access of the file, an access history buffer associated with the file, wherein the access history buffer stores a plurality of the instance of file access information, and a prefetch stream buffer configured to store a plurality of prefetch streams, wherein each of the plurality of prefetch streams is generated by satisfying a collinear check for a sequential access pattern between at least three of the plurality of the instance of file access information.

In general, in one aspect, the invention relates to a method for prefetching data in a file system comprising detecting an access to a file in the file system, wherein an instance of file access information is generated upon each access to the file, placing a plurality of the instance of file access into an access history buffer, performing a collinear check between at least three of the plurality of the instance of file access information in the history buffer to determine a sequential access pattern, creating a prefetch stream based on the sequential access pattern if the collinear check succeeds, and placing the prefetch stream into the prefetch stream buffer.

In general, in one aspect, the invention relates to a computer system for prefetching data in a file system comprising a processor, a memory, a storage device, and software instructions stored in the memory for enabling the computer system under control of the processor, to detect an access to a file in the file system, wherein an instance of file access information is generated upon each access to the file, place a plurality of the instance of file access into an access history buffer, perform a collinear check between at least three of the plurality of the instance of file access information in the history buffer to determine a sequential access pattern, create a prefetch stream based on the sequential access pattern, and place the prefetch stream into the prefetch stream buffer.

Other aspects and advantages of the invention will be apparent from the following description and the appended claims.

### BRIEF DESCRIPTION OF DRAWINGS

FIG. 1 shows a block diagram of a file system in accordance with one or more embodiments of the invention.

FIG. 2 shows a diagram of a prefetch stream buffer in accordance with one or more embodiments of the invention.

FIG. 3-4 show flow diagrams in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a file system with an infrastructure to support a prefetch strategy handling various types of sequential access patterns. In one embodiment of the invention, the prefetch strategy uses information available to the file system, prior to issuing block-device requests, to obtain more robust information about the way applications are accessing files. More specifically, in one embodiment of the invention, the file system maintains file access information (stored in a file access history buffer) about multiple accesses on a per-file basis. Further, the prefetch strategy, in one embodiment of the invention, involves a collinear check of multiple instances of access information for a file (stored in the file access history buffer) to determine the presence of a prefetch stream(s) and store the prefetch stream(s) in an appropriate buffer. A stream of data may then be fetched into memory based on the prefetch streams matching a particular sequential access pattern. In one or more embodiments of the invention, the number of blocks prefetched in a stream is dependent on the reliability of the access pattern. As more hits in a sequential access pattern are found, more blocks in the pattern are prefetched. Similarly, false positives do not trigger further prefetches and, thus, save file system resources.

In one or more embodiments of the invention, the file system of the present invention employs a prefetch strategy designed to prefetch streams of data for access patterns with both ascending block-ids and descending block-ids. Ascending block-ids are ordered in an increasing fashion. For example, an access pattern with ascending block-ids may include the block-ids 3, 5, 7, 9, etc. Descending block-ids are ordered in a decreasing fashion. For example, an access pattern with descending block-ids may read block-ids 80, 79, 78, 77, etc. Accordingly, if a file is being accessed from beginning to end, or end to beginning, the file system is able to find a sequential access pattern, if one exists. In one embodiment of the invention, the file system using the prefetch strategy is able to detect the various sequential access patterns, including a linear access pattern, a strided access pattern, and a multi-strided access pattern.

In one embodiment of the invention, a linear access pattern is one where an application accesses each block successively, one after another. An example of a linear access pattern would be block-ids 1, 2, 3, 4, 5, 6, etc.

In one embodiment of the invention, a strided access pattern is one that increases or decreases sequentially, but instead of a linear sequence, the application skips a measured stride of blocks, and accesses another in sequence.

An example of a strided access would be for block-ids 100, 110, 120, 130, 140, etc. In this case, the prefetch strategy is able to determine that the length of the stride is 10 blocks, and can prefetch blocks this distance apart.

In one embodiment of the invention, a multi-block, strided access pattern is a combination of the previous two types of access patterns. For example, assume an application accesses blocks 110, 111, and 112 in one read operation; then accesses 120, 121, and 122 in another read operation; and then accesses 130, 131, and 132 in a third read operation. Then, in one embodiment of the invention, the file system is ready and able to prefetch blocks 140, 141, 142, and so on, if these sequential accesses continue.

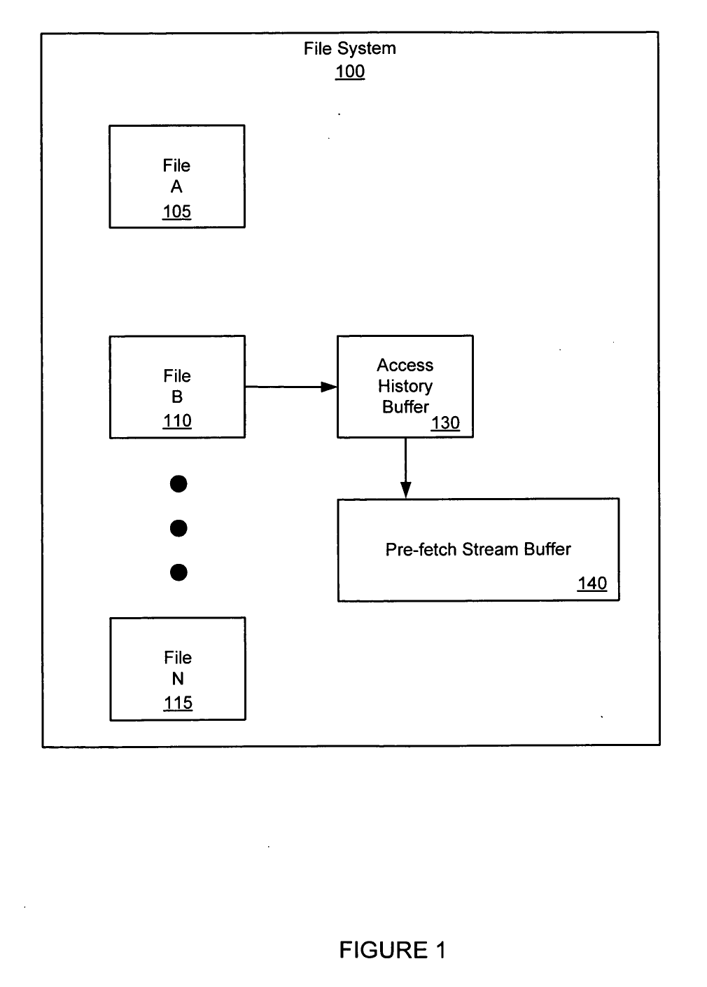

FIG. 1 shows a block diagram of a file system in accordance with one or more embodiments of the invention. The file system (100) provides a mechanism for storage and retrieval of files (e.g., File A (105), File B (110), File N (115)). The file system (100) also provides extensive programming interfaces to enable the creation and deletion of files (e.g., File A (105), File B (110), File N (115)), reading and writing of files (e.g., File A (105), File B (110), File N (115)), performing seeks within a file (e.g., File A (105), File B (110), File N (115)), creating and deleting directories, managing directory contents, and other such functionality necessary for a file system. Such activities require access to the files (e.g., File A (105), File B (110), File N (1 15)) of the file system (100).

In one or more embodiments of the invention, the file system (100) is an object-based file system (i.e., both data and metadata are stored as objects). More specifically, the file system (100) includes functionally to store both data and corresponding metadata in a storage pool (not shown). Further, in one or more embodiments of the invention, an access history buffer (130) and a prefetch stream buffer (140) are associated with each file (e.g., File A (105), File B (110), File N (115)) in the file system (100). In one or more embodiments of the invention, the access history buffer (130) and the prefetch stream buffer (140) are buffers that remain in memory while the file (e.g., File A (105), File B (110), File N (115)) exists. Each of these buffers is maintained on a per-file basis and may be stored in memory directly with the associated file or with other buffers maintained in the file system (100). Further, each of these buffers are tunable (i.e., may be as large or small as required for a particular use). Likewise, the type of data structure used for the buffer may vary depending on the type of file and the volume of data involved.

One skilled in the art will appreciate that, in one or more embodiments of the invention, the buffers may not only remain in memory, but may also be stored to a persistent data store (i.e., a storage device, a database, etc.), where the information stored in the buffer is archived and the data may be leveraged over time to predict usage patterns using various models known in the art. These usage patterns may then be used to aid in supporting more refined prefetch strategies within the file system.

The access history buffer (130) includes multiple instances of file access information associated with a file (e.g., File B (110)). Each instance of the file access information is generated when the file is accessed (e.g., File B (110)). As discussed above, the file (e.g., File B (110)) may be accessed whenever an application issues a request that is serviced by the file system (100). For example, if an application issues a modification request, the file within the file system is accessed to perform the modification. The file access information may include a variety of information about the file access, including size of the file, position of the file, requesting application, requesting thread performing the access, information about the file system during the access, etc. One skilled in the art will appreciate that maintaining file access information beyond only the block-id allows the file system to track multiple accesses per-file with various access pattern types.

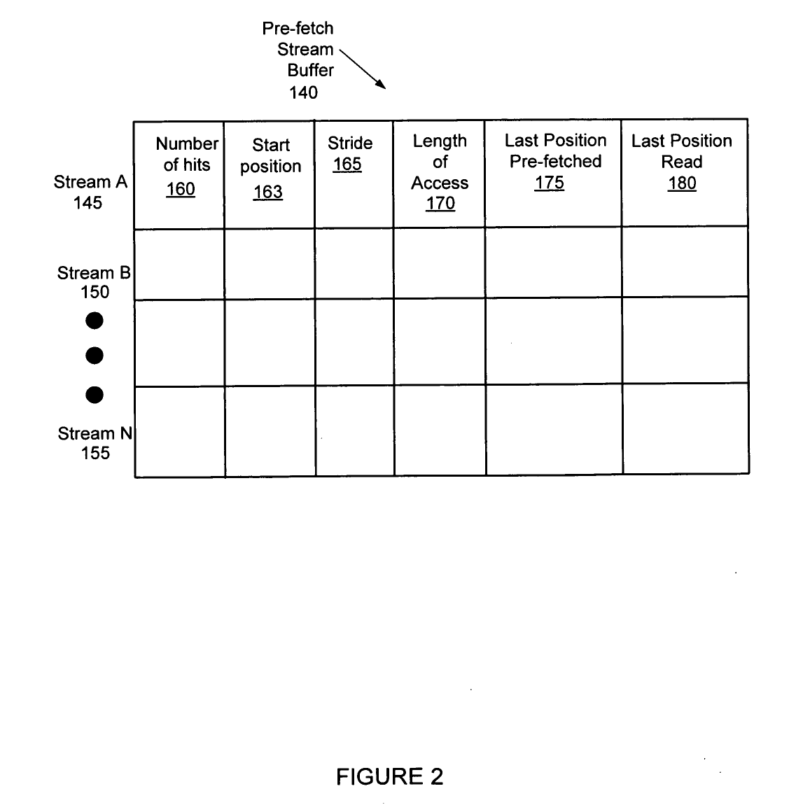

The prefetch stream buffer (140) stores prefetch streams. The prefetch streams are generated by performing a collinear check for a sequential access pattern (e.g., linear access pattern, strided access pattern, multi-strided access pattern, etc.) between instances of file access information found in the access history buffer (130). FIG. 2 shows a diagram of a prefetch stream buffer in accordance with one or more embodiments of the invention. The prefetch stream buffer (140) includes multiple prefetch streams (e.g., Stream A (145), Stream B (150), Stream N (155)). Each prefetch stream (e.g., Stream A (145), Stream B (150), Stream N (155)) includes a number of segments of information about the stream of data to be fetched within a particular file when a sequential access pattern is recognized during a file access.

For example, Stream A (145) may include the following segments of information: number of hits (160), a start position (163), a stride (165), a length of access (170), a last position prefetched (175), and a last position read (180). The number of hits (160) keeps track of how many blocks in the sequential access pattern have been read after the prefetch stream is created. Start position (163) relates to the first block-id in the sequence. For example, a pattern with block-ids 2, 4, 6, etc. have a start position of 2. Stride (165) pertains to the spacing between blocks retrieved. For example, a pattern with block-ids 3, 6, 9, 12, 15, etc. would have a stride of 3. Length of access (170) indicates the number of consecutive blocks read in a multi-block strided access pattern. For example, a multi-block strided access pattern with block-ids 0, 1, 2, 3, 4, 100, 101, 102, 103, 104, 200, 201, 202, 203, 204, etc. would have a length of access of 5 and a stride of 100. The last position prefetched (175) stores the block-id of the last block in the pattern that has been prefetched and cached, and the last position read (180) stores the block-id of the last block that has been read by an instance of file access.

In one or more embodiments of the invention, the number of hits (160) determines how aggressively the prefetch strategy should be applied. Specifically, when a sequential access pattern is already present in the prefetch stream buffer, the number of hits (160) is increased on each successive access. The increase in the number of hits (160) increases how aggressively the prefetch strategy is for a particular prefetch stream.

Specifically, in one or more embodiments of the invention, the amount of data prefetched is exponentially increased based on the number of hits in the stream. A hit is found when the next block in a sequential access pattern is read and is a measure of the sequential access pattern's reliability. For example, if a sequential access pattern is created from the block-ids 1, 2, and 3, the next block corresponding to block-id 4 is prefetched and cached. If block-id 4 is subsequently accessed by the requesting application, then two more blocks in the sequential access pattern, corresponding to block-ids 5 and 6, are prefetched and cached. Once those are read, then four more blocks (block-ids 7, 8, 9, 10) in the sequential access pattern are prefetched and cached, and so on until a set maximum prefetch amount is reached. Those skilled in the art will appreciate that the amount of data prefetched based on the number of hits may be based on another function, such as linear or factorial. Further, because the amount of data prefetched depends on the reliability of the sequential access pattern, a minimal amount of resources is taken up by false positives.

One skilled in the art will appreciate that the prefetch stream buffer shown in FIG. 2 may include fewer or greater prefetch streams. Further, each prefetch stream may be of variable length and include one or more segments of information related to the prefetch stream. Further, the prefetch streams may include different segments of information than the ones shown in FIG. 2.

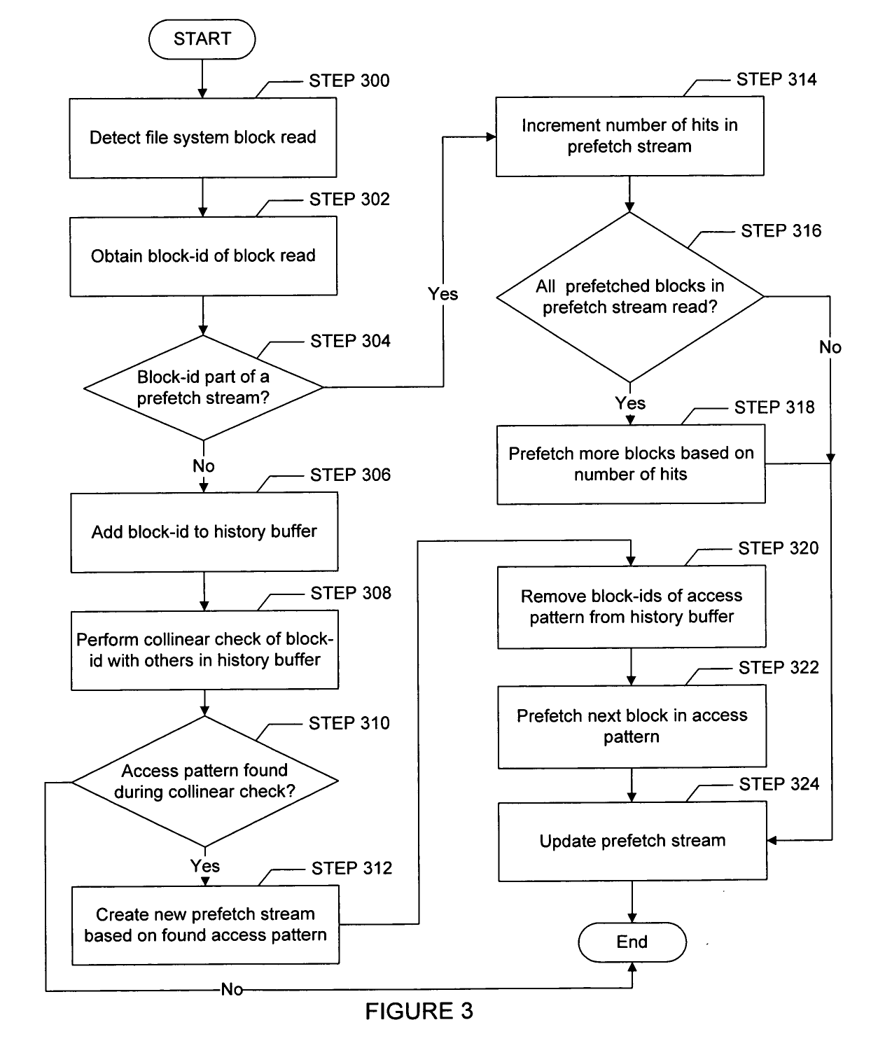

FIG. 3 shows a flow diagram for prefetching data in a file system in accordance with one or more embodiments of the invention. Initially, a block read to a file is detected (STEP 300). Once a block read is detected, the block-id of the block read is obtained (STEP 302). Next, a determination is made as to whether the block-id belongs to an existing prefetch stream (STEP 304). This may be done by iterating through existing prefetch streams and checking whether the block-id is the same as the next block-id in the sequential access pattern of the prefetch stream. If so, then a hit in the prefetch stream is found and the number of hits in the prefetch stream incremented (STEP 314). In one or more embodiments of the invention, an increase in the number of hits also corresponds to an increase of the in the aggressiveness of the prefetch strategy, as explained above.

If a hit has been made with the block-id, a check is made to determine whether all prefetched blocks in the prefetch stream have been read (STEP 316). For example, if a sequential access pattern has a starting block-id of 2, a stride of 2, a length of 1, a last read position of 6, and a last prefetched position of 10, then a new block read of block-id 8 would not read all prefetched blocks in the prefetched stream because block 10 is still prefetched and cached. In the case where not all prefetched blocks are read, the prefetch stream is updated to include the newest information and no further action is needed (STEP 324). In one or more embodiments of the invention, updating the prefetch stream (STEP 324) when all prefetched blocks have not been read involves changing the last position read in the prefetch stream.

Alternately, the last block read may by the same as the last block prefetched and intended to be read. For example, if a prefetch stream had a starting block-id of 1, a stride of 1, a length of 1, a last read position of 3, and a last prefetched position of 4, a block read of block-id 4 indicates that all prefetched blocks have been read. As a result, more blocks in the sequential access pattern are prefetched based on the number of hits in the prefetch stream (STEP 318). As stated above, the number of prefetched blocks may be a linear, exponential, or other function of the number of hits in the prefetch stream. For example, the number of prefetched blocks may be equal to the number of hits in the prefetch stream, or the number of prefetched blocks may be an exponential function that increases each time a new prefetch is conducted, as stated above (e.g. 2 blocks, 4 blocks, 8 blocks, 16 blocks, etc.).

Once more blocks are prefetched, the prefetch stream is updated to reflect the changes (STEP 324). Because the prefetch stream contains both a new block read as well as newly prefetched blocks, both the last position prefetched and last position read need to be updated. For example, in a sequential access pattern of stride 1, if the obtained block-id is 6 and four more blocks are prefetched after it, the prefetch stream is updated with a last position read of 6 and a last position prefetched of 10.

Continuing with FIG. 3, if the obtained block-id is not part of a prefetch stream, the block-id is added to the access history buffer (STEP 306). A collinear check is conducted between the newly added block-id and other block-ids in the history buffer (STEP 308) to determine whether a sequential access pattern exists (STEP 310). In one or more embodiments of the invention, a sequential access pattern is found from the collinear check when three elements that make-up a linear sequence of access history are found. For example, if blocks 1, 2, and 4 are stored in the access history buffer and the next read is performed on block 6, then a sequential access pattern is established between the accesses of blocks 2, 4, and 6. As stated above, strided and multi-strided access patterns may also be found using collinear checks. In one or more embodiments of the invention, a multi-strided access pattern may initially contain three prefetch streams. Once a pattern is established between the three streams, the three streams are combined into one stream. For example, if three streams pertain to block-ids {0, 1, 2}, {10, 11, 12}, and {20, 21, 22}, the streams could be merged into one stream with a start position of 0, a stride of 10, and a length of access of 3.

If a new sequential access pattern is found in the history buffer, a prefetch stream is created based on the sequential access pattern (STEP 312). In one or more embodiments of the invention, the prefetch stream is initialized with values for start position, stride, length of access, and last position read. Those skilled in the art will appreciate that these values may be updated later in the process, and that values like last position prefetched may be written to before the actual prefetch is executed The block-ids pertaining to the prefetch stream are removed from the history buffer (STEP 320) so that future collinear checks are simplified, and the next block in the sequential access pattern is prefetched (STEP 322). In one or more embodiments of the invention, only one block is prefetched to begin with to minimize the use of resources by false positives. Once a reliable sequential access pattern is established, more blocks are prefetched at once to speed up the file read. Once the next block is prefetched, the prefetch stream is updated to reflect the last block prefetched (STEP 324).

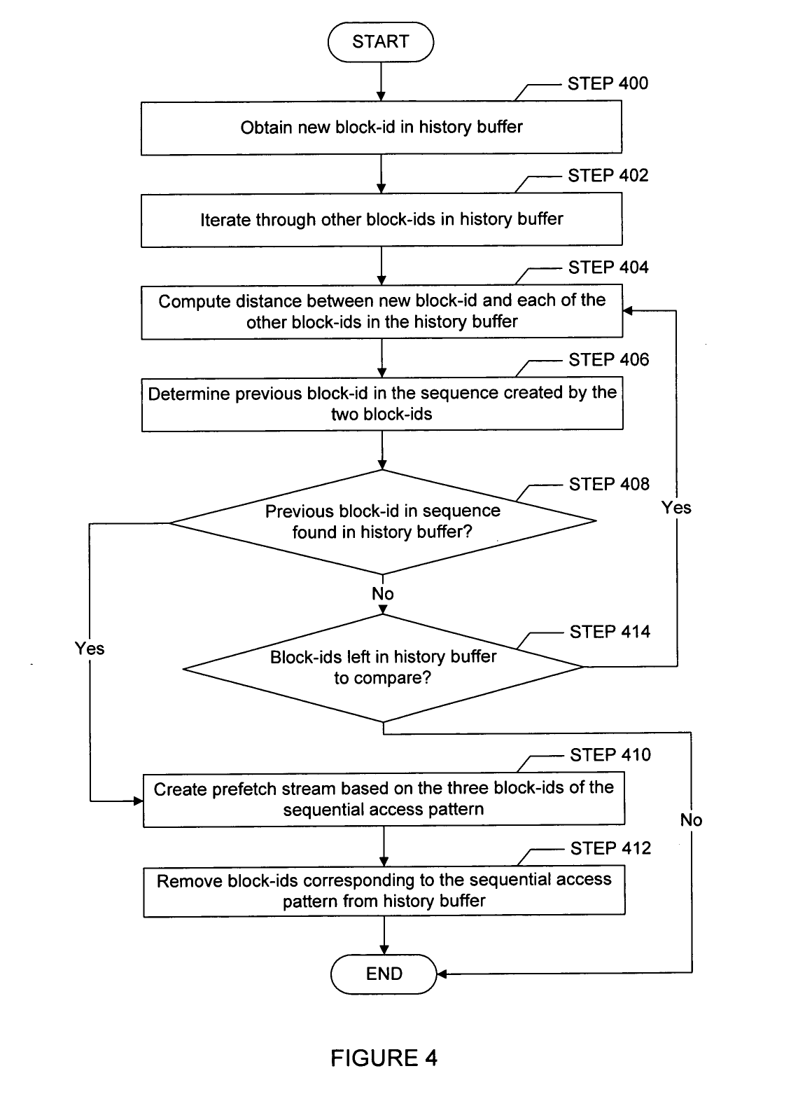

FIG. 4 shows a flow diagram for conducting a collinear check of block-ids in accordance with one or more embodiments of the invention. The collinear check is performed when a block-id is determined to not be a part of an existing prefetch stream and is used to detect new prefetch streams within block-ids in the history buffer. First, a new block-id is obtained (STEP 400). Next, an iteration through the other block-ids in the access history buffer is started so that the new block-id can be compared with all of the block-id's in the access history buffer (STEP 402). Those skilled in the art will appreciate that three block-ids are needed to perform a collinear check, and that the collinear check may be omitted if the access history buffer does not contain at least three block-ids.

Within the iteration, a distance is computed between the new block-id and each other block-id found in the access history buffer (STEP 404). This can be done by subtracting the older block-id from the new block-id. For example, the distance between a new block-id of 10 and an older block-id of 6 would be 4. Similarly, the distance between a new block-id of 4 and an older block-id of 9 would be −5. Once the distance between the two block-ids is computed (STEP 404), the previous block-id in the sequence formed by the two block-ids (i.e., the new block-id and each other block-id found in the access history buffer) is determined (STEP 406). For example, with an older block-id of 6 and a new block-id of 9, the previous block-id of the sequence formed by the two would be 3. Those skilled in the art will appreciate that a check for the next block-id in the sequence formed by a new block-id and an older block-id is not necessary because the next block-id in the sequence would come after the new block-id in order for the sequence to be valid. For example, the numbers 1, 2, and 3 form a sequential access pattern but the numbers 1, 3, and 2 do not because the numbers are out of order.

Next, a check is made to determine whether a previous block-id in the sequence formed by the new block-id and an older block-id exists in the history buffer (STEP 408). If not, a determination is made to see if any block-ids have not been compared with the new block-id (STEP 414). If any block-ids remain to compare, the iteration continues through the older block-ids in the history buffer.

If a previous block-id in the sequence formed by the new block-id and an older block-id is found in the history buffer, a sequential access pattern has been found and a prefetch stream is created based on the three block-ids of the sequential access pattern (STEP 410). As stated above, creating the prefetch stream involves filling in the fields for one or more of the following: start position, stride, length of access, last position read, last position prefetched, and number of hits. Once the prefetch stream is created, the three block-ids corresponding to the prefetch stream are removed (STEP 412), allowing future sequential access patterns to be detected more easily.

Embodiments of the invention have one or more of the following advantages. Embodiments of the invention provide much better performance when a file is being accessed by concurrent readers that exhibit different sequential access patterns. Further, applications that process matrices, database tables, otherwise deal with strided offsets, or work by traversing a file using decreasing block-ids are supported by the prefetch strategy of the present invention.

Further, multi-threaded applications, which deal with multiple streams reading the same file, also benefit from the strategy used in the present invention. For example, in many situations, streaming video servers serve the same file, but find that the clients read linearly from different offsets in the file. When implementing the prefetch strategy of the present invention, it is possible to determine how many streaming video servers are accessing the same set of blocks, and apply techniques to handle multiple applications reading from the same file at the same time, or multiple threads in an application concurrently accessing the same file.

Further, embodiments of the invention provide a prefetch strategy that uses information beyond block-id to allow the strategy to track multiple accesses per-file, giving it flexibility beyond what would be achieved by one application linearly accessing data. Additionally, the strategies employed by the file system of the present invention allow the file system to achieve optimal performance on a wide variety of applications, including those that have sequential but non-linear access patterns. Accordingly, the performance of High Performance Computing (HPC) applications, which frequently access data in matrices, improve. Database performance is also improved using the prefetch strategy of the present invention, as many databases layout tables and indices as matrices, or in other sequential but non-linear data structures. Aside from helping applications that use complicated sequential access patterns, the present invention improves the performance of applications that have multiple processes or threads concurrently accessing the same file. The prefetch strategy of the present invention tracks how each separate thread or process accesses a file, and optimizes how each individual process or thread is reading the particular file. For applications, such as streaming media servers, this creates excellent performance by tracking multiple concurrent readers, so it becomes possible to prefetch blocks for each reader, yielding additional performance wins.

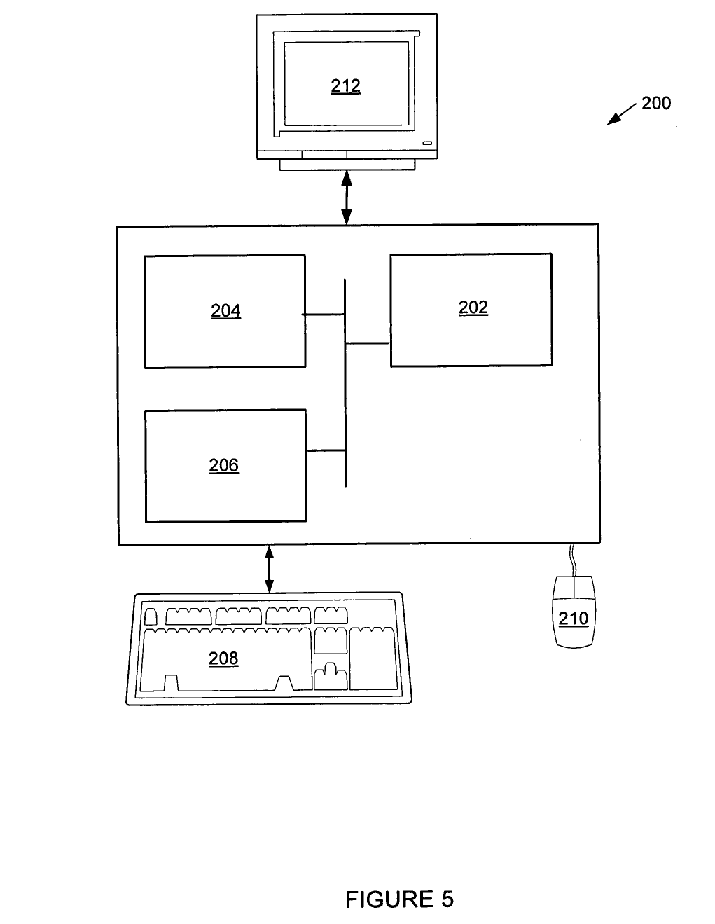

The invention may be implemented on virtually any type of computer regardless of the platform being used. For example, as shown in FIG. 5, a computer system (200) includes a processor (202), associated memory (204), a storage device (206), and numerous other elements and functionalities typical of today's computers (not shown). The computer (200) may also include input means, such as a keyboard (208) and a mouse (210), and output means, such as a monitor (212). The computer system (200) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (200) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A file system comprising:
a file accessed by the file system, wherein an instance of file access information is generated upon each access of the file;
an access history buffer associated with the file, wherein the access history buffer stores a plurality of the instance of file access information; and
a prefetch stream buffer configured to store a plurality of prefetch streams, wherein each of the plurality of prefetch streams is generated by satisfying a collinear check for a sequential access pattern between at least three of the plurality of the instance of file access information.

2. The file system of claim 1, the plurality of prefetch streams further comprising:
a stride indicating the sequential access pattern in a prefetch sequence;
a last position prefetched in the prefetch sequence; and
a last position read in the file being prefetched.

3. The file system of claim 2, the plurality of prefetch streams further comprising a number of hits indicating the use of the sequential access pattern in a prefetch stream.

4. The file system of claim 3, wherein a prefetch stream prefetches an amount of data based on the number of hits incurred on a prefetch stream.

5. The file system of claim 1, wherein the sequential access pattern is at least one selected from the group consisting of linear, strided, and multi-block strided.

6. The file system of claim 1, wherein the stream of data is fetched into a cache prior to a request for a reader.

7. The file system of claim 1, wherein generating a prefetch stream from the collinear check for a sequential access pattern removes the at least three of the plurality of the instance of file access information from the access history buffer.

8. A method for prefetching data in a file system comprising:
detecting an access to a file in the file system, wherein an instance of file access information is generated upon each access to the file;
placing a plurality of the instance of file access into an access history buffer;
performing a collinear check between at least three of the plurality of the instance of file access information in the history buffer to determine a sequential access pattern;
creating a prefetch stream based on the sequential access pattern if the collinear check succeeds; and
placing the prefetch stream into the prefetch stream buffer.

9. The method of claim 8, wherein the prefetch stream comprises:
a stride indicating the sequential access pattern in a prefetch sequence;
a last position prefetched in the prefetch sequence; and
a last position read in the file being prefetched.

10. The method of claim 8, further comprising:
fetching a stream of data into a cache based on the prefetch stream.

11. The method of claim 9, the prefetch stream further comprising:
a number of hits indicating the reliability of the sequential access pattern in a prefetch stream.

12. The method of claim 11, wherein the prefetch stream prefetches an amount of data based on the number of hits.

13. The method of claim 8, further comprising:
placing the instance of file access information from the access history buffer if the sequential access pattern is found in the prefetch stream buffer.

14. The method of claim 8, wherein the sequential access pattern is at least one selected from the group consisting of linear, strided, and multi-block strided.

15. A computer system for prefetching data in a file system comprising:
a processor;
a memory;
a storage device; and
software instructions stored in the memory for enabling the computer system under control of the processor, to:
detect an access to a file in the file system, wherein an instance of file access information is generated upon each access to the file;
place a plurality of the instance of file access into an access history buffer;
perform a collinear check between at least three of the plurality of the instance of file access information in the history buffer to determine a sequential access pattern;
create a prefetch stream based on the sequential access pattern; and
place the prefetch stream into the prefetch stream buffer.

16. The computer system of claim 15, wherein the prefetch stream comprises:
a stride indicating the sequential access pattern in a prefetch sequence;
a last position prefetched in the prefetch sequence; and
a last position read in the file being prefetched.

17. The computer system of claim 15, the software instructions further comprising:
fetching a stream of data into memory based on the prefetch stream.

18. The computer system of claim 16, the software instructions further comprising:
increasing a number of hits associated with the prefetch stream with the same sequential access pattern.

19. The computer system of claim 18, wherein a prefetch stream prefetches an amount of data based on the number of hits associated with the prefetch stream.

20. The computer system of claim 15, wherein the sequential access pattern is at least one selected from the group consisting of linear, strided, and multi-block strided.
